(19) United States
(12) Patent Application Publication
(10) Pub. No.: US 2016/0189430 A1
(43) Pub. Date: Jun. 30, 2016

(54) METHOD FOR OPERATING ELECTRONIC DATA GLASSES, AND ELECTRONIC DATA GLASSES

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 14/910,576

(22) PCT Filed: Jul. 29, 2014
(86) PCT No.: PCT/EP2014/002072

§ 371 Date: Feb. 5, 2016

(30) Foreign Application Priority Data
Aug. 16, 2013 (DE) 10 2013 013 698.9

(51) Int. Cl. G06T 19/00; G06F 3/01; G06F 3/0484; G02B 27/01; G06F 1/16; G06F 3/16

(52) U.S. Cl. CPC G06T 19/006; G06F 1/163; G06F 3/167; G06F 3/04842; G02B 27/0172; G06F 3/013; G02B 2027/0178

(57) ABSTRACT

A method operates electronic data glasses. The method involves detecting whether an object arranged outside of the data glasses lines up, at least partially, with a symbol displayed by a display device of the data glasses, and selecting the object if the object overlaps with the symbol, at least partially, and if at least one predetermined condition has been met.

### CROSS REFERENCE TO RELATED APPLICATIONS

This application is based on and hereby claims priority to International Application No. PCT/EP2014/002072 filed on Jul. 29, 2014 and German Application No. 10 2013 013 698.9 filed on Aug. 16, 2013, the contents of which are hereby incorporated by reference.

### BACKGROUND

The invention relates to a method for operating electronic data glasses and electronic data glasses.

Electronic data glasses which have a display device by which information can be shown in a field of view of a wearer of the data glasses are generally known. A wide variety of objects can be selected, such as, for example, persons, buildings and the like, for which corresponding information, if available, can be provided by data glasses of this type.

### SUMMARY

One possible object is to provide a method for operating electronic data glasses and electronic data glasses by which a simplified selection of objects can be made.

The inventor proposes a method for operating electronic data glasses, in which it is detected whether an object disposed on the outside of the data glasses is lined up at least partially with a symbol displayed by a display device of the data glasses, wherein the object is selected if it is lined up at least partially with the symbol and at least one predefined condition is satisfied. By the proposed method, a wearer of the electronic glasses can thus select a wide variety of objects that are disposed on the outside of the data glasses in a line of vision of the wearer in a particularly simple manner by the symbol, for example cross hairs or the like, serving as a selection element.

The symbol serves here as a type of static selection element, wherein a wearer of the data glasses can effect a corresponding displacement of an image segment of the display device via his head movement in order to line up objects that are of interest to him with the symbol displayed by the display device of the data glasses and thereby be able to effect a selection of the object. A wearer of the data glasses thus receives immediate and easily understandable feedback via the displayed symbol, indicating whether an object that may be of interest to him has just been lined up by the symbol so that the wearer of the data glasses, if he should wish to do so, can easily select a corresponding object that he has lined up with the displayed symbol by a corresponding head movement.

An advantageous embodiment provides that the object is selected only if a predetermined action by a wearer of the data glasses has been detected. The predetermined action is preferably a predefined voice command, a predefined blinking pattern and/or an actuation of a predefined operating element. The wearer of the data glasses can therefore quite easily effect a selection of the object by, for example, uttering a corresponding voice command, performing a corresponding blinking pattern or simply by actuating a corresponding operating element on the data glasses.

According to an alternative embodiment, it is provided that the object is selected automatically if it has been detected that the object has been lined up at least partially with the symbol for a predefined alignment period. The wearer of the data glasses must therefore only ensure that his head remains aligned accordingly for a predefined period, for example 1 second, 2 seconds or the like, in such a way that the symbol remains at least partially lined up with the object relevant to the wearer of the data glasses. A particularly convenient and intuitive selection of objects relevant to the wearer of the data glasses is enabled by the subsequent automatic selection of the object.

In a further advantageous design, in order to detect whether the object is at least partially lined up with the symbol, it is provided that a check is carried out to determine whether an area predefined on the inside of the data glasses, the symbol and the object are disposed along a common straight line. The area predefined on the inside of the data glasses may, for example, be an eye or a part of the eye of the wearer of the data glasses. It must therefore merely be checked that, for example, the one eye of the wearer of the data glasses, the displayed symbol and the object that may be of interest to the wearer of the data glasses are disposed along a common straight line. The alignment of the symbol with the object can thereby be established in a particularly simple manner.

In a further advantageous design, in order to detect whether the object is at least partially lined up with the symbol, it is provided that a check is carried out to determine whether a line of vision of a wearer of the data glasses is aligned with both the symbol and the object. For this purpose, the data glasses may, for example, have a correspondingly suitable line of vision detection device by which the line of vision of the wearer of the data glasses can be detected at any time. Through an alignment with the detected line of vision of the wearer of the data glasses in the knowledge of the displayed position of the symbol, it can be established in a particularly simple manner whether the symbol has been lined up with the object concerned. The data glasses may, for example, have a position determination or navigation module, wherein the alignment of the data glasses and information stored or made available in the position determination or navigation module relating to corresponding objects, such as, for example, buildings and the like, can be taken into account.

A further advantageous embodiment provides that, after the object has been selected, predetermined information on the selected object is reproduced visually and/or audibly. The predetermined information is preferably reproduced only if a predetermined action of the wearer of the data glasses has been detected. For example, this may involve a corresponding voice command, a corresponding blinking movement of the wearer and/or an actuation of a correspondingly predefined operating button on the data glasses.

Alternatively, it can also be provided in a further embodiment that the predetermined information is reproduced automatically if it has been detected that the object has been at least partially lined up with the symbol for at least a predefined time period following the selection, for example 1 second, 2 seconds or the like. The relevant information is therefore output automatically if the wearer of the data glasses has kept his head aligned accordingly for the predefined time period in such a way that the symbol has been at least partially lined up with the object concerned.

A further advantageous embodiment provides that an expiry of the predefined time period is indicated by the display device in the form of an animation. It is thereby made clear in a simple manner to the wearer of the data glasses that the object is currently at least partially lined up with the symbol, wherein the wearer of the data glasses can recognize from the animation how long he must keep the data glasses aligned accordingly with the object concerned before the predetermined information is output automatically.

In a further advantageous design, it is provided that the predetermined information is displayed only for as long as it is detected that the object is at least partially lined up with the symbol. It is thereby prevented that any information that is no longer of interest is hidden in a timely manner if the wearer of the data glasses is no longer interested in corresponding information relating to the previously aligned object.

According to a further advantageous embodiment, it is provided that the object is selected only if predetermined information is present for the object. In addition, it can also be provided that the object is only selectable at all if predetermined information is present for the object. The predetermined information may, for example, be information stored in the data memory of the data glasses or corresponding information stored in a database separate from the data glasses, said information being accessible, for example, via a corresponding Internet connection. A check is therefore preferably always carried out to determine whether an object that can currently be aligned with the data glasses is stored at all in one or more databases which can be accessed with the data glasses. In fact, if no information at all is present for the object concerned, a corresponding selection of the object would also be pointless. Corresponding objects in the surroundings of the data glasses may, for example, be presented as highlighted accordingly by the display device, for example framed, color-coded or characterized in some other way, for which objects any corresponding information at all is present. A wearer of the data glasses is thereby simply made aware of the objects for which he can obtain any information at all in his surroundings via the data glasses.

A further advantageous embodiment provides that, as soon as the object has been selected, a visual highlighting is displayed in a predefined area of the display device. The wearer of the data glasses can thereby recognize directly that a corresponding object has just been focused on and selected by the data glasses. On the basis of this information, the wearer of the data glasses can decide, for example, whether he would like to obtain any further information at all on the object that has just been selected or whether, where relevant, the object which the wearer of the data glasses actually wanted to focus on and obtain corresponding information on has erroneously not been selected at all.

A further advantageous embodiment provides that, as soon as it is detected that the object is at least partially lined up with the symbol, a predefined area encompassing the object is displayed by the display device, magnified by a predefined factor. In other words, a partial zoom of a part of the surroundings can therefore be effected by the display device of the data glasses, so that the wearer of the data glasses receives surrounding areas that may be relevant to him represented as at least partially magnified, so that he can better focus on objects present in this area with the displayed symbol. For example, the partial zoom may be a kind of fisheye effect, whereby a partial area of the surrounding area relevant to the wearer of the data glasses can be displayed as magnified and distorted.

The inventor also proposes electronic data glasses that comprise a detection device which is designed to detect whether an object disposed on the outside of the data glasses is at least partially lined up with a symbol displayed by the display device of the data glasses. Furthermore, the electronic data glasses comprise a control device which is designed to select the object if the latter is at least partially lined up with the symbol and at least one predetermined condition is satisfied. Advantageous designs of the proposed method are to be regarded as advantageous designs of the proposed electronic data glasses, wherein the latter comprise, in particular, devices to carry out the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic perspective view of electronic data glasses with a display device by which a wide variety of information can be shown in a field of view of a wearer of the data glasses; and

FIG. 2 shows a schematic representation of the display device of the data glasses, wherein, by the display device, cross hairs are displayed which serve to enable the wearer of the data glasses to select an object which is disposed on the outside of the data glasses.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

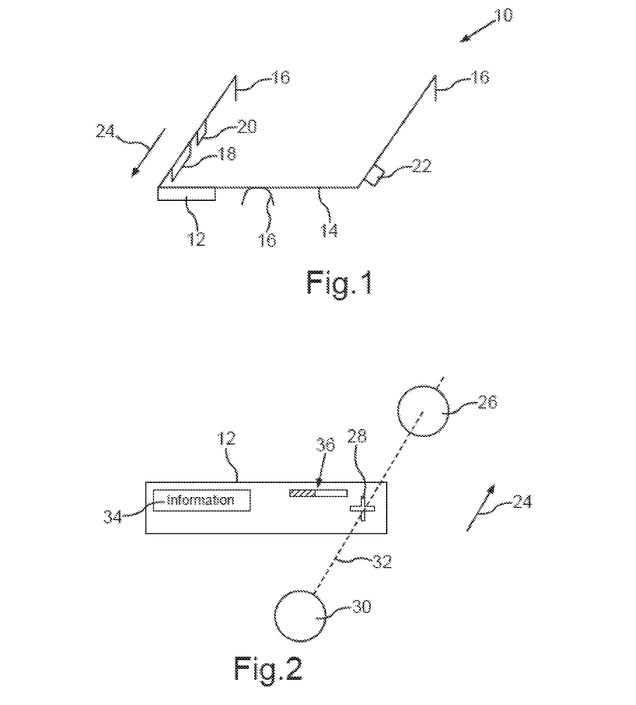

Electronic data glasses 10 are shown in a schematic perspective view in FIG. 1. The electronic data glasses 10 comprise a display device 12 which is disposed on a frame 14 of the data glasses 10. In the present case, the electronic data glasses 10 comprise a plurality of arms 16 by which a wearer can place the data glasses 10 on his ears or nasal bone.

The data glasses 10 furthermore comprise a detection device 18, a control device 20 and an operating element 22. A direction of observation of a wearer of the data glasses 10 is indicated by the arrow 24.

A method for operating the electronic data glasses 10 is explained in detail below. FIG. 2 shows a schematic view of the display device 12. By the detection device 18, it is detected whether an object disposed on the outside of the data glasses 10 is at least partially lined up with a symbol 28 displayed by the display device 12 of the data glasses 10. In the present case, the symbol 28 is a type of cross hairs, wherein the symbol 28 can also be displayed in a further wide variety of shapes.

The object 26 is selected by the control device 20 if said object is at least partially lined up with the symbol 28 and satisfies at least one predetermined condition.

The object 26 is selected only if a predetermined action by the wearer of the data glasses 10 has been detected. The predetermined action may, for example, be a predefined voice command which the wearer of the data glasses 10 utters in order to select the object 26 aligned by him. Alternatively or additionally, the predetermined action may also be a predefined blinking pattern and/or an actuation of the operating element 22, after which the correspondingly aligned object 26 is selected.

Alternatively, it is also possible for the object 26 to be selected automatically if it has been detected that the object 26 has been at least partially lined up with the symbol 28 for a predefined alignment period. The predefined alignment period may, for example, be 1 second, 2 seconds or the like. Furthermore, it can be indicated by the data glasses 10 whether any information at all is present for the object 26, for example in the form of data which are stored in a storage device of the data glasses (not shown here) or in a storage device separate from the data glasses 10 which can be accessed, for example, via an Internet connection. If corresponding information on the object 26 were present, this can be communicated, for example, by a corresponding display (not shown here) within the display device 12, so that the wearer of the data glasses 10 is made aware that any information at all is present for the object 26. Furthermore, the object 26 is also selected only if correspondingly predetermined information is present for the object 26.

In order to detect whether the object 26 is at least partially lined up with the symbol 28, a check is carried out to determine whether an area 30 predefined on the inside of the data glasses 10, the symbol 28 and the object 26 are arranged along a common straight line 32. The predefined area 30 may, for example, be an eye of the wearer of the data glasses 10, so that, by the check to determine whether the predefined area 30, the symbol 28 and the object 26 are disposed along the straight line 32, a check can easily be carried out to determine whether the wearer of the data glasses 10 has just focused on the object 26.

Alternatively or additionally, it is also possible, in order to detect whether the object 26 is at least partially lined up with the symbol 28, to check whether a line of vision of the relevant wearer of the data glasses 10 is directed at both the symbol 28 and the object 26.

The selection of the object 26 serves to provide the wearer with further information on the object 26 by the data glasses 10. After the object 26 has been selected, at least predetermined information 34 is shown by the display device 12. Alternatively or additionally, it is also possible for this predetermined information to be reproduced audibly by the data glasses 10 via a corresponding loudspeaker.

The predetermined information 34 is reproduced only if a predetermined action of the wearer of the data glasses 10 has been detected. The predetermined action of the wearer may be that said wearer utters, for example, a corresponding voice command, performs a correspondingly predefined blinking pattern or actuates the operating element 22 once more.

Alternatively, it is also possible for the predetermined information 34 to be reproduced automatically if it has been detected that the object 26 is at least partially lined up with the symbol 28 for at least a predefined time period following the selection. A corresponding expiry of the predefined time period may, for example, be indicated by the display device 12 in the form of an animation 36. If the object 26 has therefore already been selected, the bar-shaped animation 36 is filled as the time period increases, wherein, as soon as the bar-shaped animation 36 is completely filled, the predefined time period has elapsed and the corresponding information 34 is displayed automatically.

The predetermined information 34 is indicated only for as long as it is detected that the object 26 is at least partially lined up with the symbol 28. If the wearer looks away from the object 26, the continued display of the information 34, which is then most probably no longer of interest to the wearer of the data glasses 10, is thereby prevented.

It is furthermore possible that, as soon as the object 26 has been selected, a visual highlighting (not shown here) is displayed in a predefined area of the display device 12, so that it is indicated in a clear manner to the wearer of the data glasses 10 that the object 26 concerned has just been selected by him or by the data glasses 10.

In order to simplify a selection of the object 26 by the wearer of the data glasses 10, the data glasses 10 may have a type of zoom function, so the object 26 can be selected exactly by the user of the data glasses 10. As soon as it is detected that the object 26 is at least partially lined up with the symbol 28, a predefined area encompassing the object 26 is displayed by the display device 12, magnified by a predefined factor. For example, this partial magnification or zooming in can take place only if the wearer of the data glasses 10 performs a corresponding voice command or some other action, such as, for example, an actuation of the operating element 22. This partial zoom may, for example, take place in the form of a fisheye effect or in the form of a normal zoom, so that the wearer of the data glasses 10 is presented by the display device 12 with the object 26 and a surrounding area of the object 26 magnified, for example as if he were looking through binoculars.

The object 26 may be a wide variety of elements such as, for example, buildings, vehicles or people. For example, it is possible for the wearer of the data glasses 10 to use the latter to carry out maintenance on an engine of a motor vehicle. The object 26 may then be, for example, corresponding components of the engine which he can select in the previously described manner and have corresponding information on it displayed to him.

It is also possible, for example, for a doctor to use the data glasses 10 in order to examine a patient, wherein he can select a wide variety of body regions by the data glasses in the previously explained manner and can have more detailed information displayed to him.

Is also possible for a driver of a motor vehicle to wear the data glasses 10 and use the data glasses 10 in the manner described above in order to select a wide variety of buildings, other road users or the like and have information thereon output to him by the data glasses 10.

The data glasses 10 can therefore substantially be used for any fields of application in which any objects are selected by a wearer of the data glasses 10 in order to have more detailed information on the object that has just been selected displayed to him, if required.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

1-15. (canceled)

16. A method for operating electronic data glasses that have a display device, comprising:
detecting whether a line of vision of a wearer of the data glasses is aligned with both a symbol displayed by the display device of the data glasses and with an object spaced away from the data glasses;
determining that the object is at least partially lined up with the symbol if the line of vision is aligned with both the symbol and the object; and
selecting the object if the object is at least partially lined up with the symbol and at least one predetermined condition is satisfied.

17. The method as claimed in claim 16, wherein
the predetermined condition is a predetermined action by the wearer of the data glasses, and
the object is selected only if the object is at least partially lined up with the symbol and the predetermined action by the wearer of the data glasses has been detected.

18. The method as claimed in claim 17, wherein
the predetermined action is at least one action selected from the group consisting of a predefined voice command, a predefined blinking pattern and an actuation of a predefined operating element.

19. The method as claimed in claim 16, wherein
the predetermined condition is the object remaining at least partially lined up with the symbol for a predefined alignment period, and
the object is selected automatically if the object is at least partially lined up with the symbol and the object remains at least partially lined up with the symbol for at least the predefined alignment period.

20. The method as claimed in claim 16, wherein
the data glasses have an outer side and an inner side,
the object is positioned on and spaced away from the outer side of the data glasses,
a predefined area is positioned on and spaced away from the inner side of the data glasses such that the data glasses are positioned between the object and the predefined area, and
in order to detect whether the object is at least partially lined up with the symbol, a check is carried out to determine whether the predefined area, the symbol and the object are all disposed along a common straight line.

21. The method as claimed in claim 16, wherein
in order to detect whether the object is at least partially lined up with the symbol, eyes of the wearer of the data glasses are examined to check whether the wearer of the data glasses is focusing on the object.

22. The method as claimed in claim 16, wherein
after the object has been selected, predetermined information relating to the object is reproduced visually and/or audibly.

23. The method as claimed in claim 22, wherein
the predetermined condition is a predetermined action by the wearer of the data glasses,
the object is selected only if the object is at least partially lined up with the symbol and the predetermined action by the wearer of the data glasses has been detected, and
selection of the object triggers automatic reproduction of the predetermined information.

24. The method as claimed in claim 22, wherein
the predetermined condition is the object remaining at least partially lined up with the symbol for a predefined alignment period,
the object is selected automatically if the object is at least partially lined up with the symbol and the object remains at least partially lined up with the symbol for at least the predefined alignment period, and
selection of the object triggers automatic reproduction of the predetermined information.

25. The method as claimed in 24, wherein
an expiry of the predefined alignment period is indicated by the display device as an animation.

26. The method as claimed in claim 24, wherein
the display device displays an animation to represent the predefined alignment period, the animation providing information to the wearer of the data glasses regarding how much time remains before the predetermined alignment period expires.

27. The method as claimed in claim 22, wherein
the predetermined information is reproduced only for as long as the object is at least partially lined up with the symbol.

28. The method as claimed in claim 22, wherein
the predetermined information is reproduced by the display device of the data glasses.

29. The method as claimed in claim 16, wherein
the object is selected only if predetermined information is present for the object.

30. The method as claimed in claim 16, wherein
there are a plurality of items within a field of vision of the wearer of the data glasses,
of the items within the field of vision, predetermined information is only available for selectable objects, and
the object is selected only if predetermined information is present for the object such that the object is selected from the plurality of selectable objects.

31. The method as claimed in claim 30, wherein
the display device of the data glasses visually offsets the selectable objects from a remainder of the items within the field of vision.

32. The method as claimed in claim 31, wherein
the display device of the data glasses visually offsets the selectable objects using framing or color coding for each selectable object.

33. The method as claimed in claim 16, wherein
as soon as the object has been selected, a visual highlighting is displayed in a predefined area of the display device.

34. The method as claimed in claim 16, wherein
after the object has been selected, predetermined information relating to the object is reproduced visually and/or audibly, and
a visual highlighting is displayed in the display device so that the wearer of the data glasses can recognize that the object has been focused on, and on the basis of visual highlighting, the wearer of the data glasses can decide to obtain further information on the object.

35. The method as claimed in claim 16, wherein
as soon as it is detected that the object is at least partially lined up with the symbol, a predefined area encompassing the object is displayed by the display device, magnified by a predefined increased magnification factor.

36. Electronic data glasses comprising:
a display device;
a detection device to detect whether a line of vision of a wearer of the data glasses is aligned with both a symbol displayed by the display device and with an object spaced away from the data glasses, to thereby detect whether the object is at least partially lined up with the symbol; and
a control device to check whether the line of vision of the wearer of the data glasses is aligned with both the symbol and the object and to select the object if the object is at least partially lined up with the symbol and at least one predetermined condition is satisfied.
